(19) United States
(12) Patent Application Publication
(10) Pub. No.: US 2009/0150975 A1
(43) Pub. Date: Jun. 11, 2009

(54) METHOD AND APPARATUS FOR PROVIDING INTERNET GATEWAY SERVICE USING PLURALITY OF UNIVERSAL PLUG AND PLAY INTERNET GATEWAY DEVICES

(75) Inventors: Seong-ho CHO, Seoul (KR); Joo-yeol LEE, Seoul (KR); Se-hee HAN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/323,940

(22) Filed: Nov. 26, 2008

Related U.S. Application Data
(60) Provisional application No. 61/012,498, filed on Dec. 10, 2007.

(30) Foreign Application Priority Data
Mar. 13, 2008 (KR) 10-2008-0023450

(51) Int. Cl. G06F 15/16; G06F 21/00

(52) U.S. Cl. 726/3; 709/232

(57) ABSTRACT

Provided is a Universal Plug and Play (UPnP) Internet Gateway Device (IGD). A plurality of IGDs existing in a UPnP network interchange IGD information that is managed in order to provide a gateway service with each other, and thus the bandwidth of a device connected to the Internet can be increased, handover of a device can be successfully performed in the presence of an error of an IGD, and loads can be balanced between a plurality of IGDs. Accordingly, various Internet services can be efficiently provided to the UPnP device.

### CROSS-REFERENCE TO RELATED PATENT APPLICATION

This application claims the benefit of U.S. Provisional Application No. 61/012,498, filed on Dec. 10, 2007, in the U.S. Patent and Trademark Office, and priority from Korean Patent Application No. 10-2008-0023450, filed on Mar. 13, 2008, in the Korean Intellectual Property Office, the disclosures of which are incorporated herein in their entirety by reference.

### BACKGROUND OF THE INVENTION

1. Field of the Invention

The present invention relates to a Universal Plug and Play (UPnP) device, and more particularly, to a UPnP Internet Gateway Device (IGD).

2. Description of the Related Art

As various Internet access technologies have been continually developed, a terminal and gateway utilizing a new type of Internet access technology have been introduced allowing Internet service via various types of access technologies virtually anywhere. In addition, Internet access technologies have diversified and performance speed has increased. Accordingly, the number of devices utilizing new access technologies have also increased. Furthermore, these devices are more likely to be used as gateways in homes. Generally, a device that has various network interfaces and can be connected to the Internet can provide an Internet gateway service.

A Universal Plug and Play (UPnP) Internet Gateway Device (IGD) provides Internet connectivity to devices of a subnet. Subordinate devices and services for the gateway are defined in an Internet Gateway Device standard. A UPnP device providing a UPnP IGD Device Control Protocol (DCP) may function as a gateway.

FIG. 1 is a conceptual view for illustrating a function of a UPnP IGD. Referring to FIG. 1, by connecting a LANDevice included in a UPnP IGD to an Internet Service Provider (ISP), and by connecting a WANDevice to clients (UPnP devices) nested in a Local Area Network (LAN), Internet connectivity is provided to devices of a UPnP network. Since a detailed description of a UPnP IGD is given by the UPnP IGD standard, a detailed description thereof will not be given here.

Recently, a new gateway has been gradually introduced to homes for home-networking with respect to various devices. In particular, with regard to a Small Office Home Office (SOHO) or an enterprise network, it is efficient to employ various gateways in order to achieve load balancing and to ensure a high Quality of Service (QoS) and the like. However, according to UPnP standards in the related art, one IGD is assumed to exist in one UPnP network, and there is no method in the related art that can efficiently connect a plurality of IGDs to the Internet.

### SUMMARY OF THE INVENTION

The present invention provides a method and apparatus that efficiently provides an Internet gateway service to Universal Plug and Play (UPnP) devices by using a UPnP network.

According to an aspect of the present invention, there is provided a communicating method of a first Internet Gateway Device (IGD) in a Universal Plug and Play (UPnP) network, the method comprising: discovering a second IGD in the UPnP network; interchanging IGD information with the discovered second IGD; and providing a gateway service to a device associated with the second IGD, based on the IGD information that is received from the second IGD.

The received IGD information may comprise at least one of: information regarding devices associated with the second IGD, information regarding a mean bandwidth, information regarding a mean delay, information regarding the amount of traffic, information regarding available bandwidth, information regarding a Queue and information regarding an access network.

The discovering of the second IGD may be performed via a UPnP discovery message.

The providing of the gateway service may comprise providing an additional bandwidth to the device associated with the second IGD, based on the received IGD information.

The providing of the gateway service may comprise performing handover of the device from the second IGD to the first IGD, based on the received IGD information.

The performing of the handover may comprise: detecting an error of the second IGD; and associating with the device associated with the second IGD, based on the received IGD information.

The detecting of the error comprises determining that the error has occurred in the second IGD when an Internet Control Message Protocol (ICMP) Router Advertisement (RA) message or a UPnP discovery message, which is periodically transmitted by the second IGD, is not received within a predetermined period of time.

The interchanging of the IGD information may be periodically performed, and the detecting of the error may comprise determining that the error has occurred in the second IGD if the IGD information is not received from the second IGD within a predetermined period of time.

The method may further comprise performing authentication of the discovered second IGD, wherein the interchanging is performed only if the authentication is successful.

According to another aspect of the present invention, there is provided a computer readable recording medium having recorded thereon a program for executing the method.

According to another aspect of the present invention, there is provided a UPnP apparatus operating as a first IGD in a UPnP network, the apparatus comprising: a discovery unit discovering a second IGD in the UPnP network; an information interchange unit interchanging IGD information with the discovered second IGD; and a gateway service providing unit providing a gateway service to a device associated with the second IGD, based on the IGD information that is received from the second IGD.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual view for illustrating a function of a Universal Plug and Play (UPnP) Internet Gateway Device (IGD);

FIG. 2 is a flow chart of a communicating operation performed by an IGD, according to an exemplary embodiment of the present invention;

FIGS. 3A and 3B are flow charts of a handover operation of a UPnP device, according to an exemplary embodiment of the present invention;

FIG. 4 is a flow chart of a handover operation of a UPnP device when an error arises in an IGD, according to an exemplary embodiment of the present invention.

FIG. 5 is a flow chart of a load balancing operation, according to an exemplary embodiment of the present invention;

FIG. 6 is a flow chart of a remote management operation of an IGD, according to an exemplary embodiment of the present invention; and

FIG. 7 is a structural view of a gateway apparatus including an IGD, according to an exemplary embodiment of the present invention.

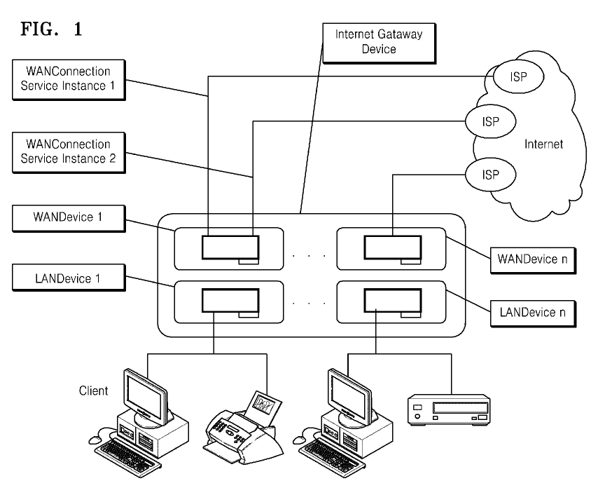

### DETAILED DESCRIPTION OF THE INVENTION

Hereinafter, the present invention will be described in detail by explaining exemplary embodiments of the invention with reference to the attached drawings. Hereinafter, two Internet Gateway Devices (IGDs) (i.e., first and second IGDs) are assumed to exist in a Universal Plug and Play (UPnP) network, but it will be obvious to one of ordinary skill in the art that the present invention can be applied to a plurality of IGDs. In addition, the term “UPNP device” and the term “device” are used interchangeably.

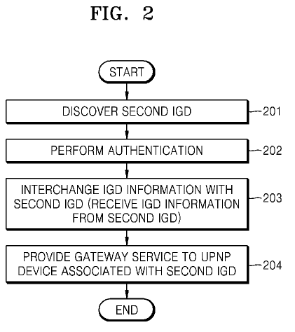

FIG. 2 is a flow chart of a communicating operation performed by an IGD, according to an exemplary embodiment of the present invention. In particular, FIG. 2 illustrates an operation of the first IGD under conditions in which the first IGD coexists with the second IGD.

In operation 201, the first IGD discovers the second IGD. This discovery is performed via a UPnP discovery message which the second IGD periodically broadcasts.

During operation, the first IGD and the second IGD authenticates each other. At this time, the authentication may be performed by using various methods such as: a method disclosed in Chapter 8: Security of IEEE 802.11s, an authentication method based on Wi-Fi Protected Setup (WPS), an authentication method performed by inputting a Personal Identification Number (PIN), or the like.

By performing the authentication, various attacks can be prevented. For example, an IGD that is not authenticated can be prevented from illegally using a bandwidth of a network, intercepting existing traffic in order to forward it to a location that is not desired by a user, or analyzing data.

In operation 203, the first IGD interchanges IGD information with the second IGD. The IGD information refers to all information that is managed by an IGD in order to provide a gateway service to a subnet of itself, i.e., the IGD. For example, the IGD information includes information regarding devices associated with an IGD, information regarding a mean bandwidth, information regarding a mean delay, information regarding the amount of traffic, information regarding available bandwidths, information regarding a Queue, information regarding an access network (i.e., information regarding a Dynamic Host Configuration Protocol (DHCP) server/Domain Name Server (DNS), a subnet mask, default router, etc.) or the like.

In operation 204, the first IGD provides a gateway service to a UPnP device associated with the second IGD (i.e., a UPnP device nested in a subnet of the second IGD). Likewise, according to the current exemplary embodiment, a plurality of IGDs interchange IGD information with each other, and thus an IGD can provide a gateway service to a device associated with another IGD. Such technology can be applied to performing a handover, load balancing, bandwidth expansion, error recovery, etc, which will be described below in more detail.

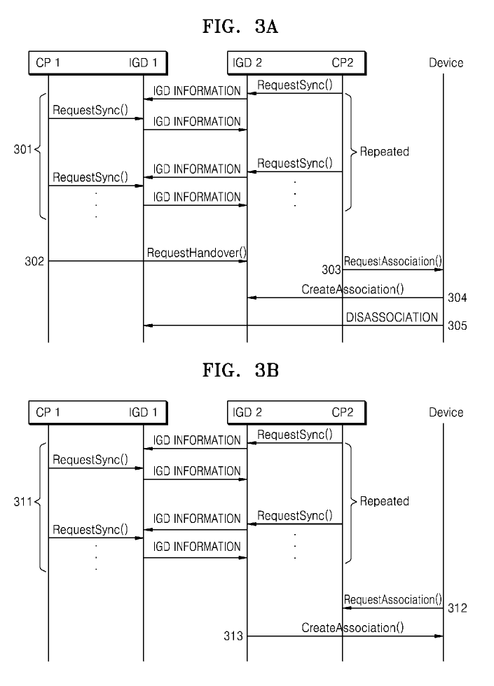

FIGS. 3A and 3B are flow charts of a handover operation of a UPnP device, according to an exemplary embodiment of the present invention.

Referring to FIG. 3A, a Control Point (CP) 1 may exist as an Embedded CP of an IGD 1, and a CP2 may exist as an Embedded CP of IGD 2. Alternatively, the CP1 and the CP2 may exist externally to the IGD1 and IGD2. When the CP1 and the CP2 exist externally to the IGD1 and IGD2, the CP1 and the CP2 may be associated as a single CP. Here, the CP1 and CP2 are assumed to be embedded control points of IGD 1 and IGD 2 respectively.

In addition, the device illustrated in FIG. 3A is assumed to be initially associated with the IGD 1.

In operation 301, the IGD 1 interchanges IGD information with the IGD 2. An action for interchanging the IGD information can be newly defined with regard to a IGD service, and thus is referred to as RequestSync( ). By periodically interchanging the IGD information (i.e., synchronization), the latest IGD information can be maintained.

In operation 302, the CP1 requests the IGD 2 to associate the device with CP2. A handover action of the device can be newly defined, and thus is referred to as RequestHandover( ).

In operation 303, the embedded CP2 of the IGD2 requests association with the device.

In operation 304, the device is associated with the IGD 2. At this time, since the IGD 2 previously received information regarding the device from the IGD 1, the device and the IGD 2 can be quickly associated with each other without performing an authentication process.

In operation 305, the device releases the existing association with the IGD 1.

In the meantime, messages used in operations 303 through 305 may be newly defined with regard to the UPnP network. Alternatively, Media Independent HandOver (MIHO) messages defined in IEEE 802.21 may be used as the messages used in operations 303 through 305.

Until the device is associated with the IGD 2, a data packet received via the Internet is transferred from the IGD 1 to the IGD 2, thereby preventing data packet loss.

The handover of a UPnP device of FIG. 3B is performed under the same conditions as FIG. 3A except that the handover is performed by request of the device instead of by request of an IGD.

Operation 311 is the same as operation 310 illustrated in FIG. 3A, and thus its description will not be given here.

In operation 312, the device requests association with the embedded CP2 of the IGD 2.

In operation 313, when authentication and resource assignment are successfully completed, the IGD 2 achieves association with the device via CreateAssociation( ).

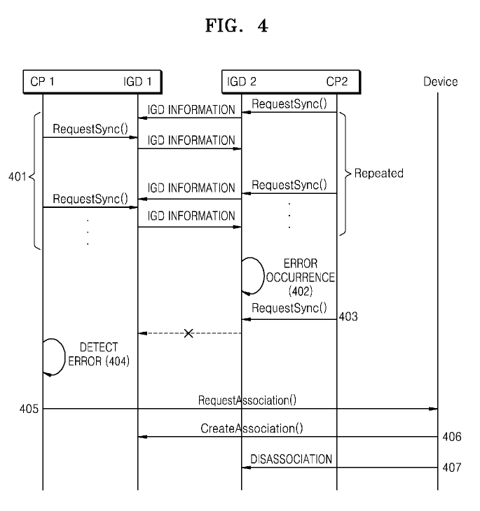

FIG. 4 is a flow chart of a handover operation of a UPnP device when an error arises in an IGD, according to an exemplary embodiment of the present invention.

The device is assumed to be associated with an IGD 2. Operation 401 is the same as operation 301 illustrated in FIG. 3A, and thus its description will not be given here.

In operation 402, an error arises in the IGD 2, and thus IGD 2 may not operate normally.

In operation 403, a CP2 first calls RequestSync( ) of the IGD 2 from when the error occurred, according to a predetermined interchange cycle of IGD information. However, the IGD information of the IGD 2 is not received by the IGD 1, due to the error of the IGD 2.

In operation 404, the CP1 recognizes that the IGD information of the IGD 2 is not received by the IGD 1 even though the interchange cycle of the IGD information elapses, and thus the CP1 can detect the error of the IGD 2.

In the current exemplary embodiment, the error of the IGD 2 is detected by using the interchange cycle of the IGD information. However, the error of the IGD 2 may be detected according to whether an Internet Control Message Protocol (ICMP) Router Advertisement (RA) message or a UPnP discovery message is received by the IGD 1 within a predetermined period of time.

In operation 405, the CP1, which detects the error of the IGD 2, requests association with the device that is associated with the IGD 2.

In operation 406, the device achieves association with the IGD 1. As described above, the IGD 1 previously receives information regarding the device from the IGD 2, and thus the description of an authentication process will not be given here.

In operation 407, the device currently associated with IGD 1 releases the association with the IGD 2.

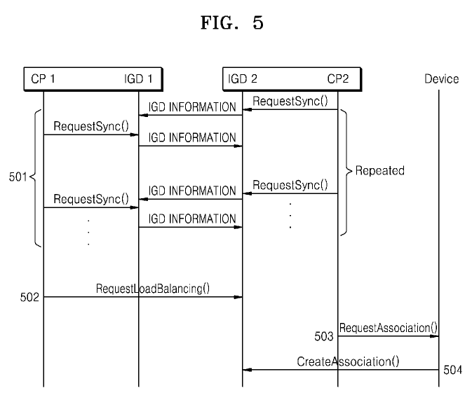

FIG. 5 is a flow chart of a load balancing operation, according to an exemplary embodiment of the present invention.

A device is assumed to be associated with an IGD 1. Operation 501 is the same as operation 301 illustrated in FIG. 3A, and thus its description will not be given here.

In operation 502, the CP1 previously receives information regarding a mean bandwidth, a Queue, a packet processing delay, etc. of the IGD 2, and thus the CP1 requests that the IGD 2 should balance and process the traffic load of the CP1. In the presence of an IGD 3 (not shown) having more resources than the IGD 2, the CP1 may request that the IGD 3 should perform the load balancing. The CP1 determines a neighboring IGD to be selected, according to IGD information that is previously interchanged.

In operation 503, the CP2 requests that the device should be associated with the IGD2.

In operation 504, the device is associated with the IGD 2.

In the current exemplary embodiment, since a plurality of IGDs may perform the load balancing, the device does not release an existing association with an IGD even though the device is associated with another IGD, unlike in the case of the handover. As the load balancing is performed, the IGD 2 supplements the IGD 1 so as to process a part of existing traffic transferred between the IGD 1 and the device.

In the meantime, when the device is associated with a plurality of IGDs, bandwidth aggregation may be performed instead of the load balancing. That is, the IGD 2 may provide additional bandwidths to the device, and thus the device can obtain an improved QoS compared with the case where a device utilizes an Internet service as in the related art via only the IGD 1.

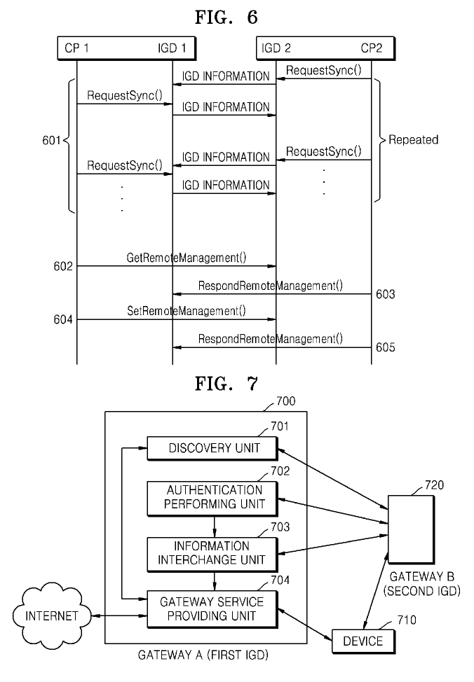

FIG. 6 is a flow chart of a remote management operation of an IGD, according to an exemplary embodiment of the present invention.

Operation 601 is the same as operation 301 illustrated in FIG. 3A, and thus its description will not be given here.

In the current exemplary embodiment, it is assumed that IGD 1 may connect to the Internet and IGD 2 may not connect to the Internet. In this case, a subnet of the IGD 2 is a type of network nested in a subnet of the IGD 1. In addition, a WAN Device of the IGD 2 communicates with a LAN Device of the IGD 1, and the LAN Device of the IGD 2 communicates with a device nested in the subnet of the IGD 2, i.e., associated with the IGD 2.

Since IGD 2 may not connect to the Internet, the IGD 2 communicates with the IGD 1 so that a remote management server (not shown) manages the settings of the IGD 2, wherein the remote management server is disposed outside of a UPnP network (i.e., the subnet of the IGD 1). At this time, the remote management server and a WAN interface (i.e., WAN Device) of the IGD 1 may communicate with each other by using a protocol such as TR-069 defined in the Digital Subscriber Line (DSL) Forum or the Simple Network Management Protocol (SNMP) defined by the Internet Engineering Task Force (IETF).

In operation 602, the CP1 converts a management information requesting message according to a UPnP protocol, wherein the management information request message is received from the remote management server according to a remote management protocol, and then transmits the converted management information requesting message to the IGD 2 via a GetRemoteManagement( ) action that is newly defined in the current exemplary embodiment.

In operation 603, the CP2 transmits management information to the IGD 1 via a RespondRemoteManagement( ) action. The CP 1 converts the management information according to the remote management protocol, and then transmits the management information to the remote management server.

Since the management information is included in IGD information, the IGD 1 may directly transfer the management information of the IGD 2 to the remote management server without performing operations 602 and 603. However, in this case, the IGD information may not be the latest in format ion.

In operation 604, when the CP1 receives a management message from the remote management server, the CP1 converts the management message according to the UPnP protocol, and then transmits the converted management message to the IGD 2 via a SetRemoteManagement( ) action.

In operation 605, the CP2 returns a result parameter to the IGD 1 via the RespondRemoteManagement( ) action. The CP1 converts the result parameter according to the remote management protocol, and then transmits the converted result parameter to the remote management server.

FIG. 7 is a structural view of a gateway apparatus 700 including an IGD, according to an exemplary embodiment of the present invention.

The gateway apparatus 700 includes a discovery unit 701, an authentication performing unit 702, an information interchange unit 703 and a gateway service providing unit 704.

The discovery unit 701 discovers a second IGD 720. This discovery may be performed via a discovery message which the second IGD 720 periodically broadcasts.

The authentication performing unit 702 and the second IGD 720 authenticates each other. At this time, the authentication may be performed by using various methods.

When authentication is successful with respect to the second IGD 720, the information interchange unit 703 interchanges IGD information with the second IGD 720. As described above, the IGD information refers to all information that is managed by an IGD in order to provide a gateway service to a subnet of itself, i.e., the IGD. For example, the IGD information includes information regarding devices associated with an IGD, information regarding the mean bandwidth, information regarding the mean delay, information regarding the amount of traffic, information regarding available bandwidth, information regarding a Queue, information regarding an access network (i.e., information regarding a DHCP server/DNS, a subnet mask, a default router, etc.) or the like.

The gateway service providing unit 704 provides the gateway service to a UPnP device 710 associated with the second IGD 720, based on the IGD information of the second IGD 720. As described above, the gateway service may be applied to the performing of a handover, bandwidth aggregation, error restoration, QoS ensurance, remote management, or the like.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, and optical data storage devices.

The invention can also be embodied as computer readable codes on a computer readable transmission medium. Examples of the computer readable transmission medium include carrier waves (such as data transmission through the Internet).

According the above exemplary embodiments of the present invention, the bandwidth of a device connected to the Internet can be increased in a UPnP network, handover of a device can be successfully performed in the presence of an error of an IGD, and traffic loads can be balanced between a plurality of IGDs.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A communicating method of a first Internet Gateway Device (IGD) in a Universal Plug and Play (UPnP) network, the method comprising:
discovering a second IGD in the UPnP network;
interchanging a first IGD information of the first IGD with a second IGD information of the second IGD; and
providing a gateway service to a device associated with the second IGD based on the second IGD information.

2. The method of claim 1, wherein the second IGD information comprises at least one of information regarding devices associated with the second IGD, information regarding a mean bandwidth, information regarding a mean delay, information regarding an amount of traffic, information regarding available bandwidth, information regarding a Queue and information regarding an access network.

3. The method of claim 1, wherein the discovering of the second IGD is performed via a UPnP discovery message.

4. The method of claim 1, wherein the providing of the gateway service comprises providing an additional bandwidth to the device associated with the second IGD based on the second IGD information.

5. The method of claim 1, wherein the providing of the gateway service comprises performing handover of the device from the second IGD to the first IGD based on the second IGD information.

6. The method of claim 5, wherein the performing of the handover comprises:
detecting an error of the second IGD; and
associating the first IGD with the device associated with the second IGD based on the second IGD information.

7. The method of claim 6, wherein the detecting of the error comprises determining that the error has occurred in the second IGD if an Internet Control Message Protocol (ICMP) Router Advertisement (RA) message or a UPnP discovery message, which is periodically transmitted by the second IGD, is not received within a predetermined period of time.

8. The method of claim 6, wherein the interchanging of the IGD information is periodically performed, and
the detecting of the error comprises determining that the error has occurred in the second IGD if the IGD information is not received from the second IGD within a predetermined period of time.

9. The method of claim 1, further comprising performing authentication of the second IGD, wherein the interchanging the first IGD information of the first IGD with the second IGD information of the second IGD is performed only if the authentication is successful.

10. A Universal Plug and Play (UPnP) apparatus operating as a first Internet Gateway Device (IGD) in a UPnP network, the apparatus comprising:
a discovery unit which discovers a second IGD in the UPnP network;
an information interchange unit which interchanges a first IGD information of the first IGD with a second IGD information of the second IGD; and
a gateway service providing unit which provides a gateway service to a device associated with the second IGD based on the second IGD information.

11. The apparatus of claim 10, wherein the second IGD information comprises at least one of information regarding devices associated with the second IGD, information regarding a mean bandwidth, information regarding a mean delay, information regarding an amount of traffic, information regarding available bandwidth, information regarding a Queue and information regarding an access network.

12. The apparatus of claim 10, wherein the discovery unit discovers the second IGD via a UPnP discovery message.

13. The apparatus of claim 10, wherein the gateway service providing unit provides an additional bandwidth to the device associated with the second IGD based on the second IGD information.

14. The apparatus of claim 10, wherein the gateway service providing unit comprises a handover performing unit which performs handover of the device from the second IGD to the first IGD based on the second IGD information.

15. The apparatus of claim 14, wherein the handover performing unit detects an error of the second IGD, and if the error is detected, the handover performing unit associates with the device associated with the second IGD based on the second IGD information.

16. The apparatus of claim 15, wherein the handover performing unit determines that the error has occurred in the second IGD if an Internet Control Message Protocol (ICMP) Router Advertisement (RA) message or a UPnP message, which is periodically transmitted by the second IGD, is not received within a predetermined period of time.

17. The apparatus of claim 15, wherein the information interchange unit periodically interchanges the IGD information, and
the handover performing unit determines that the error has occurred in the second IGD if the IGD information is not received from the second IGD within a predetermined period of time.

18. The apparatus of claim 10, further comprising an authentication performing unit which performs authentication of the discovered second IGD, wherein the information interchange unit interchanges the first IGD information and the second IGD information only if the authentication is successful.

19. A computer readable recording medium having a program recorded thereon, the program if executed by a computer causes the computer to execute the method of claim 1.
